(19) United States
(12) Patent Application Publication
(10) Pub. No.: US 2014/0110353 A1
(43) Pub. Date: Apr. 24, 2014

(54) FLOATING APPARATUS AND METHOD FOR CLEANING WATER IN A POOL OR TANK

(71) Applicant: INDUSTRIAL TECHNOLOGY RESEARCH INSTITUTE, Chutung Township (TW)

(72) Inventor: Hsien-Chen MA, Chutung Township (TW)

(73) Assignee: INDUSTRIAL TECHNOLOGY RESEARCH INSTITUTE, Chutung Township (TW)

(21) Appl. No.: 13/655,288

(22) Filed: Oct. 18, 2012

(51) Int. Cl. C02F 1/78; E04H 4/16

(52) U.S. Cl. 210/760; 210/167.11; 210/192; 210/136

(57) ABSTRACT

A floating apparatus and method for cleaning water in a pool or tank are provided. The floating apparatus includes: a body having at least one discharge outlet; an electrical power source having a solar power collector that is mounted on a top portion of the body, wherein the body has a contour wall for allowing the solar power collector to face up; an ozone generator connected to the electrical power source; an ozone conduit in gas communication with the ozone generator and the at least one discharge outlet; and a transparent cover covering the solar power collector, whereby ozone produced in the ozone generator is discharged from the discharge outlet and provides the power for moving the floating apparatus.

### BACKGROUND

1. Technical Field

The disclosure relates to an apparatus for cleaning water in a pool or tank by using photovoltaic technology and produced ozone as driving power thereof.

2. Description of Related Art

Chlorine is the most widely used method of neutralizing disease causing pathogens and bacteria in a body of water. However, even though chlorine is relatively inexpensive as compared to other types of sanitizers, the cost of chlorine, for instance to sanitize a pool, becomes an extremely expensive proposition over the lifetime of the pool.

Other methods of disinfection include use of ozonators. Ozone generators or ozonators have been utilized in connection with fixed or permanent swimming pool water purification systems, as well as in various commercial and industrial water treatment processes. The ozone is typically introduced as a pressurized gas into a pipeline through a diffusing pipe passing through a side wall of the pool or tank.

One of the conventional designs for incorporating the ozonator with a water treatment apparatus comprises a housing that is placed in the water, an electrical ozone generator mounted in the housing and connected to an electrical power source, an atmospheric air intake conduit passing through a wall of the housing and in gas communication with the ozone generator, and an ozone discharge outlet extending from the ozone generator and in gas communication with the water, whereby ozone produced in the generator is discharged for diffusion into the surrounding water.

Another floating cabin for cleaning water is reported, composed of a spherical cabin body with air inlet on its top, a lower air pipeline network having air outlet nozzles which is disposed on the bottom portion of the cabin in disorder with air outlet nozzles in the water to be cleaned, an air compressor communicated with said air pipeline network, and a power supply.

However, in those apparatuses above mentioned, the prevention of entry of water into the apparatus is achieved by employing a mechanism of positive pressure.

### SUMMARY

A floating apparatus for cleaning water in a pool or tank is disclosed. The apparatus comprises: a body having a rudder that has at least one discharge outlet; an electrical power source having a solar power collector that is mounted on a top portion of the body, wherein the body has a contour wall for allowing the solar power collector to face up; an ozone generator connected to the electrical power source; an ozone conduit in gas communication with the ozone generator and the at least one discharge outlet, whereby ozone produced in the ozone generator is discharged from the discharge outlet; and a transparent cover covering the solar power collector.

Another floating apparatus for cleaning water in a pool or tank is also provided. The floating apparatus comprises: a body having an opening positioned at a top portion thereof, and having at least one discharge outlet, and an annular wall formed on an edge of the opening; an electrical power source having a solar power collector that is mounted on the top portion of the body, wherein the body has a contour wall for allowing the solar power collector to face up; an ozone generator connected to the electrical power source; an ozone conduit in gas communication with the ozone generator and the at least one discharge outlet, whereby ozone produced in the ozone generator is discharged from the discharge outlet; and a transparent cover covering the solar power collector.

A method for cleaning water in a pool or tank by using the floating apparatus of the disclosure is also provided.

### BRIEF DESCRIPTION OF DRAWINGS

FIG. 1 is an exploded view of an embodiment of the floating apparatus for cleaning water in a pool or tank according to the disclosure; and

FIG. 2 is a side elevated view of an embodiment of the floating apparatus for cleaning water in a pool or tank according to the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

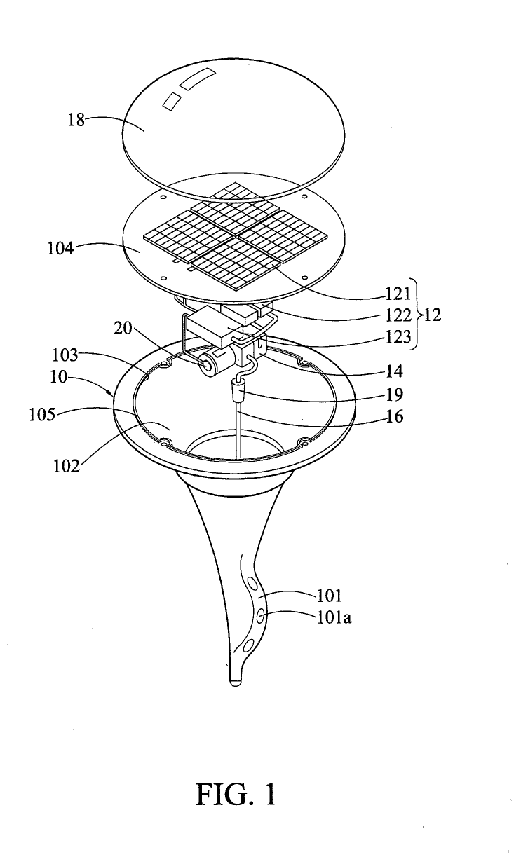

Referring to FIG. 1, an exploded view of an embodiment of the floating apparatus for cleaning water in a pool or tank according to the disclosure is provided. The floating apparatus comprises a body 10, an electrical power source 12, an ozone generator 14, an ozone conduit 16, and a transparent cover 18.

In an embodiment, the body 10 has a rudder 101 positioned, for example, at a bottom portion thereof, and the rudder 101 has at least one discharge outlet 101a. As shown in the exemplified example of FIG. 1, the body 10 has a cone-shaped contour wall having the shape wider on the top and narrow down on bottom. The body 10 has an inner space 102 for accommodating devices disposed under a cap 104, such as the ozone generator 14, an ozone conduit 16, a rechargeable battery 122, and an adapting circuit 123; and an opening 103 correspondingly positioned at the top portion of the body 10. The body 10 is buoyant and floats on the surface of the water during operation or not, which has the cone-shaped contour wall for allowing the opening 103 to face up.

In an embodiment, the body 10 further has the cap 104 such as a metal plate, covering the opening 103 and bearing the solar power collector 121. In a non-limiting example, the cap 104 can be fixed by screw(s) or bolt(s) (not shown).

The electrical power source 12 is mounted on the top portion of the body 10, and comprises a solar power collector 121 and a rechargeable battery 122 electrically connected to the solar power collector 121. As shown in FIG. 1, in order to face the sun, the top portion of the body 10 has a cross section area big enough to allow the opening 103 to face up. For this reason, the solar power collector 121 is installed on the surface of the cap 104.

Besides, the electrical power source 12 further comprises a voltage adapting circuit 123 between the solar power collector 121 and the rechargeable battery 122.

The ozone generator 14 is connected to the electrical power source 12, specifically powered by the rechargeable battery 122. A recharging current is provided by the solar power collector 121, such as a solar module composed of several photovoltaic panels.

The ozone conduit 16 is in gas communication with the ozone generator 14 and the at least one discharge outlet 101a, whereby ozone produced in the ozone generator 14 is discharged from the discharge outlet 101a. In order to guard against the entry of water into the body 10, a check valve structure 19 is formed in the at least one discharge outlet 101a or the ozone conduit 16. In an embodiment, the check valve structure 19 is formed in the ozone conduit 16. In another embodiment, a check valve is fitted in gas communication with the discharge outlet 101a.

In an embodiment, the floating apparatus further comprises an air compressor 20 in gas communicated with the ozone generator 14 so that the appropriate amount and pressure of air is delivered to the ozone generator 14. As a result, the ozone produced in the ozone generator 14 offers the power for moving the floating apparatus.

In another embodiment, the floating apparatus further comprises a timer (not shown) electrically connected to the electrical power source 12 and/or ozone generator 14.

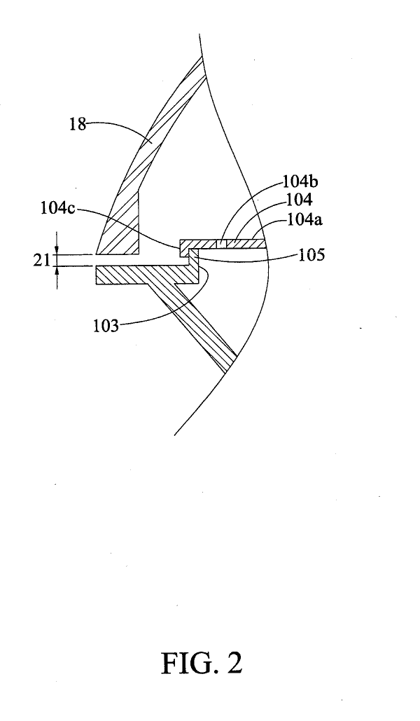

Referring now to FIG. 2, a side elevated view of an embodiment of the floating apparatus for cleaning water in a pool or tank according to the disclosure is provided.

As shown in FIG. 2, a gap 21 exists as an air intake between the transparent cover 18 and the top portion of the body 10. Besides, the top end of the gap 21 is lower than the top surface 104a of the cap 104 for preventing the entry of water onto the cap 104. In an embodiment, the cap 104 further has a through hole 104b as another air intake.

In an embodiment, in order to guard against the entry of water into the body 10, the body 10 has an annular wall 105 formed on the edge of opening 103. In an example, the annular wall 105 is higher than the gap 21 so as to raise the cap 104.

In the embodiment of FIG. 2, the cap 104 has an extension portion 104c formed on the edge of the bottom surface of the cap 104, which matches the annular wall 105. For example, the extension portion 104c is annular.

In an embodiment of the body 10 having annular wall 105, a gap 21 exists as an air intake between the transparent cover 18 and the top portion of the body 10. Besides, the body 10 further has a cap 104 covering the opening 103 and bearing the solar power collector 121, wherein the top end of the gap 21 is lower than the top surface 104a of the cap 104.

In an embodiment, the cap 104 covers on the annular wall 105 to further guard against any water that may find its way into the body 10.

In the embodiment of the body 10 having the annular wall 105, the floating apparatus can further comprise a check valve structure 19 formed in the at least one discharge outlet 101a or the ozone conduit 16, wherein the at least one discharge outlet 101a is formed at the bottom portion of the body 10.

In an example, the body 10 has a rudder 101 positioned, for example, at the bottom portion thereof, and the at least one discharge outlet 101a is formed on the rudder 101 for leading the direction of movement.

In another example, the rudder 101 has a plurality of discharge outlets 101a that are arranged to allow the ozone be discharged in the same direction.

In the embodiment of the body 10 having annular wall 105, the electrical power source 12 can further have a rechargeable battery 122 that is electrically connected to the solar power collector 121, and a voltage adapting circuit 123 and an air compressor 20 can be included in the floating apparatus.

The disclosure also provides a method for cleaning water in a pool or tank by using the floating apparatus above mentioned, comprising placing the floating apparatus in the body of water contained in a pool or tank; and starting the floating apparatus.

Colony Numbers Test

A floating apparatus of the disclosure was operated for three days, generating ozone 30 minutes a day with an ozone concentration of 20 ppm at the outlet, followed by placing it on a surface of 150 L tap water contained in a container.

In a comparative example that the floating apparatus was not employed, the colony number of total bacteria and Escherichia coli in the container measured were 9,000 CFU/mL and 300 CFU/100 mL, respectively.

In comparison with the comparative example, after the treatment of water is conducted by the floating apparatus according to the disclosure, the colony number of total bacteria and Escherichia coli were reduced to 15 CFU/mL and 24 CFU/100 mL, respectively. As a result of the significant decrease of the colony numbers, the floating apparatus according to the disclosure is suitable for cleaning water in a pool or tank.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A floating apparatus for cleaning water in a pool or tank, comprising:
a body having a rudder that has at least one discharge outlet;
an electrical power source having a solar power collector that is mounted on a top portion of the body, wherein the body has a contour wall for allowing the solar power collector to face up;
an ozone generator connected to the electrical power source;
an ozone conduit in gas communication with the ozone generator and the at least one discharge outlet, whereby ozone produced in the ozone generator is discharged from the discharge outlet; and
a transparent cover covering the solar power collector.

2. The floating apparatus of claim 1, wherein the body further has an opening positioned at the top portion of the body, and a cap covering the opening and bearing the solar power collector.

3. The floating apparatus of claim 1, further comprising a check valve structure formed in the at least one discharge outlet or the ozone conduit.

4. The floating apparatus of claim 1, wherein the rudder has a plurality of discharge outlets that are arranged to allow the ozone to be discharged in the same direction.

5. The floating apparatus of claim 1, wherein the electrical power source further has a rechargeable battery that is electrically connected to the solar power collector.

6. The floating apparatus of claim 5, further comprising a voltage adapting circuit between the solar power collector and the rechargeable battery.

7. The floating apparatus of claim 1, further comprising an air compressor in gas communicated with the ozone generator.

8. The floating apparatus of claim 1, wherein a gap exists as an air intake between the transparent cover and the top portion of the body.

9. The floating apparatus of claim 8, wherein the body further has a cap covering the opening and bearing the solar power collector, and wherein a top end of the gap is lower than a top surface of the cap.

10. A floating apparatus for cleaning water in a pool or tank, comprising:
a body having an opening positioned at a top portion thereof, and having at least one discharge outlet, and a annular wall formed on an edge of the opening;
an electrical power source having a solar power collector that is mounted on the top portion of the body, wherein the body has a contour wall for allowing the solar power collector to face up;
an ozone generator connected to the electrical power source;
an ozone conduit in gas communication with the ozone generator and the at least one discharge outlet, whereby ozone produced in the ozone generator is discharged from the discharge outlet; and
a transparent cover covering the solar power collector.

11. The floating apparatus of claim 10, wherein a gap exists as an air intake between the transparent cover and the top portion of the body.

12. The floating apparatus of claim 11, wherein the body further has a cap covering the opening and bearing the solar power collector, and wherein a top end of the gap is lower than a top surface of the cap.

13. The floating apparatus of claim 10, further comprising a check valve structure formed in the at least one discharge outlet or the ozone conduit.

14. The floating apparatus of claim 10, wherein the body has a rudder positioned at a bottom portion thereof, and the rudder has at least one discharge outlet.

15. The floating apparatus of claim 14, wherein the rudder has a plurality of discharge outlets that are arranged to allow the ozone to be discharged in the same direction.

16. The floating apparatus of claim 10, wherein the electrical power source further has a rechargeable battery that is electrically connected to the solar power collector.

17. The floating apparatus of claim 16, further comprising a voltage adapting circuit between the solar power collector and the rechargeable battery.

18. The floating apparatus of claim 10, further comprising an air compressor in gas communicated with the ozone generator.

19. A method for cleaning water in a pool or tank by using the floating apparatus of claim 1.

20. The method of claim 19, comprising:
placing the floating apparatus in a body of water contained in a pool or tank; and starting the floating apparatus.

21. A method for cleaning water in a pool or tank by using the floating apparatus of claim 10.
